(19) United States
(12) Patent Application Publication
(10) Pub. No.: US 2014/0035464 A1
(43) Pub. Date: Feb. 6, 2014

(54) CONTROLLING AN EVENT BEHAVIOR OF AN ILLUMINATION INTERFACE FOR A NETWORK DEVICE

(71) Applicants: David L. Santos, Granite Bay, CA (US); Giuseppe Scaglione, Granite Bay, CA (US)

(72) Inventors: David L. Santos, Granite Bay, CA (US); Giuseppe Scaglione, Granite Bay, CA (US)

(21) Appl. No.: 13/563,416

(22) Filed: Jul. 31, 2012

(51) Int. Cl. H05B 37/02

(52) U.S. Cl. 315/130

(57) ABSTRACT

A network device includes an LED interface that exhibits behaviors corresponding to detected events. In a first mode, at least one from a set of predefined event behaviors are selected for the LED interface. The behaviors are responsive to pre-programmed criteria. In a second mode, a new event behavior is implemented for the LED interface in response to criteria not included in the pre-set criteria.

### BACKGROUND

Ethernet switches are often aggregated by the thousands inside large data centers. The switches are generally disposed in housings, and include various circuitry and software. External indicators, such as light-emitting-diodes (LEDs) provide technicians or other users with fixed and basic information regarding internal functionality of the switch. There are circumstances where it may be helpful to evaluate and provide additional LED indicators of switch functionality, especially for troubleshooting purposes.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example network device that employs a programmable illumination interface;

FIG. 2 illustrates an example flowchart including steps for choosing an event corresponding to a desired illumination behavior;

FIG. 3 illustrates an example flowchart including steps for configuring an event to correlate with desired illumination behavior;

FIG. 4 illustrates an example flowchart including steps for managing illumination events; and

FIG. 5 illustrates an example flowchart including steps for programming an illumination to exhibit a desired behavior in response to a certain event.

### DETAILED DESCRIPTION

Examples described herein provide methods and associated apparatus for allowing a network administrator to program illumination components such as LEDs associated with network devices. This provides additional flexibility in visually communicating network and/or network device functionality to a person viewing the network device.

According to one example, a network device is described that includes an illumination interface (e.g., LED interface) that exhibits behaviors corresponding to detected events. The network device can be accessed. In a first mode, the network device is controlled, programmed or signaled to exhibit at least one event behavior from a set of predefined event behaviors for the illumination interface. The behaviors are responsive to pre-set criteria. In a second mode, the network device is controlled, programmed or signaled to exhibit different event behavior for the illumination interface in response to criteria not included in the pre-set criteria.

In numerous examples described herein, the illumination component is described as an LED, although variations may provide for other kinds of illumination components, such as incandescent or lasing components.

According to a further example, a network device is configured by logic (e.g., programming such as provided through software, firmware or hardware) to carry out data networking operations in response to software instructions and an access interface for coupling to the logic. The device includes at least one illumination component having a predefined behavior responsive to a pre-set event.

In an example described, a programmable or controllable interface couples to the access interface and the LED to configure the at least one LED to exhibit additional behaviors responsive to additional events.

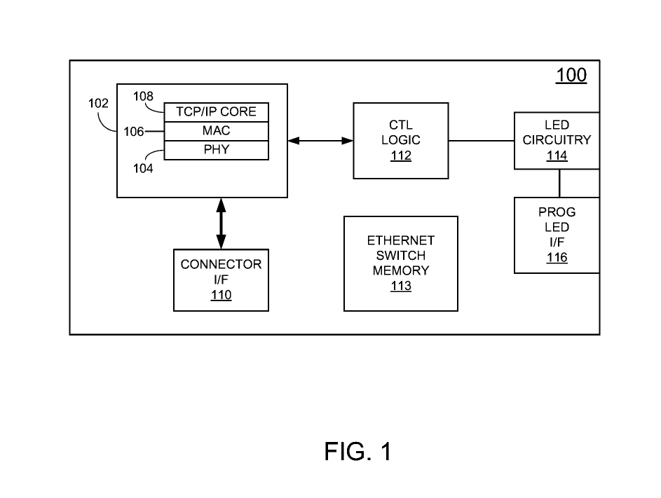

Referring now to FIG. 1, one example of a network device, generally designated 100 and in the form of an Ethernet switch, includes software and hardware resources sufficient to support an IP protocol layer framework 102 compatible with, for example, IPv4 and/or IPv6. The framework includes a physical interface layer (PHY) 104, a media access control (MAC) layer 106, and a transport control protocol (TCP/IP) core layer 108. A connector interface 110, such as a magjack or RJ-type connector provides an access port for coupling the network device 100 to a network (not shown), such as a local area network (LAN), wide area network (WAN) or, for example, the Internet.

In some examples, the network device 100 may be one of several devices networked together in the local area network (LAN) and/or wide area network (WAN) via routers, hubs, switches, and the like. As used herein a “network device” means a switch, router, hub, bridge, access point, etc., e.g., a router having processor and memory resources and connected to a network (not shown).

In some examples, devices can be connected to one another and/or to other networks using routers, hubs, and/or switches, among other devices. As noted above, such devices can include a processor in communication with a memory and may include network chips having hardware logic, e.g., in the form of application specific integrated circuits (ASICs), associated with the number of network ports. The term “network” as used herein is not limited to the number, type, and/or configuration of devices illustrated in FIG. 1.

Further referring to FIG. 1, the network device 100 includes control logic 112 that operates in accordance with software and/or firmware stored in a memory 114. The control logic 112, among other things, controls the operation of LED circuitry 114. The LED circuitry 114 includes one or more LEDs that operate in multiple modes of operation, such as a default mode corresponding to default LED settings, and a programmable mode, where the LED settings may be updated and/or modified. The default mode is a standard operating mode where the LEDs exhibit preset default behaviors upon the occurrence of certain events. For example, an update to the switch firmware might be represented as a preset event that, upon occurrence, causes the LED to, for example, turn on or blink rapidly, thereby providing a visual indication to someone external to the switch that the event occurred. Other default events might include a switch reboot, a switch crash, or a configuration update.

With continued reference to FIG. 1, the network device 100 also includes a programmable or controllable LED interface 116 to reconfigure the LED circuitry 114 to exhibit new behaviors responsive to newly defined events. Additionally, the programmable LED interface 116 allows a network user or administrator to access a database of predefined LED behaviors and define new events with corresponding LED behaviors. Further, the programmability enables a remote administrator to access the LED interface and program one or more events and LED behaviors to communicate with someone in local proximity to the network device who can visually observe the LED behaviors and confirm the event actually occurred. In this way, the administrators or users can utilize existing LED interfaces to communicate internal operating criteria associated with the switch externally, thereby allowing for more efficient troubleshooting and/or problem resolution.

### Methodology

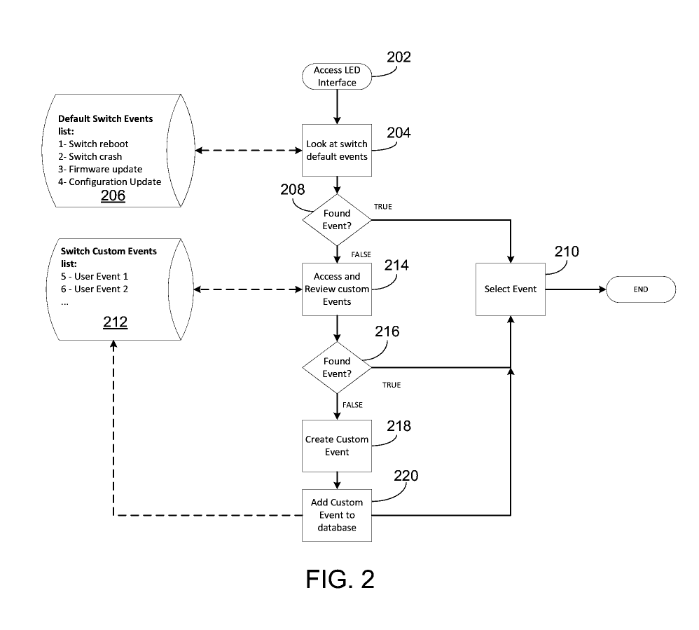

FIG. 2 through FIG. 5 illustrate example methods for use of a programmable LED interface for network devices. Example methods such as described may be implemented using logic or processing resources, such as provided on computers (e.g., servers), including network devices or integrated circuits.

Referring now to FIG. 2, a flowchart is illustrated that includes a sequence of steps employed in one example of a method for a user to choose an event. Choosing an event is an initial step undertaken in the overall LED—event programming method described herein. The programmable LED interface may be accessed by a user either remotely, via network routing, or locally through a laptop (or other diagnosis device) connection to the magjack connector interface 110. The interface may be realized through application software directly executed on, for example, a laptop, or through a website application accessed over the internet via the laptop or other computing device.

Further referring to FIG. 2, once connected, the user may access the LED interface software, at step 202, and review switch default events, at step 204, that are stored in a default event database 206. If a desired event is identified, at step 208, consistent with the user's requirements, then the event is selected, at step 210. However, if the event is not in the list of default events, then a list of custom events is accessed from a custom switch event database 212, and reviewed at step 214. If the desired event matches up with a previously configured custom event, at step 216, then the event is selected, at 210. If not listed in the custom events list, the user is then prompted, at step 218, to create the new event. Further detail on configuring newly created events and programming LED behaviors is described below. After configuring the new event, it is added to the custom events database 212 at step 220, and selected by the user, at 210.

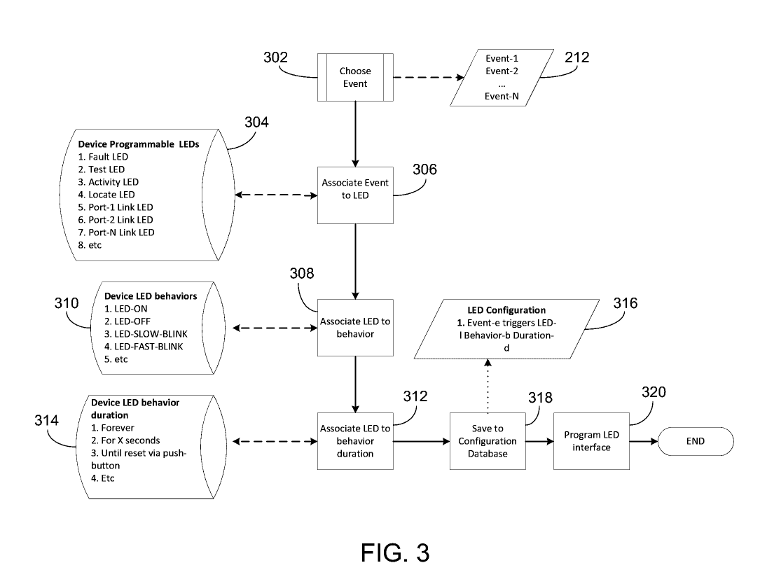

FIG. 3 illustrates a flowchart setting forth further detail relating to steps carried out in configuring the newly created custom events described above with respect to FIG. 2. After a custom event is created and stored in the custom event database 212, a user configures the event by first selecting the event via the LED interface software, at step 302. The user then accesses a stored listing 304 of available programmable LEDs that may be associated with the event. For applications involving network switches, each network switch port often includes at least two LEDs. With many switches having forty-eight or more ports, there may be up to one-hundred LEDs to work with for a given network administrator in programming the switch LEDs. Specific LED examples may include a fault LED, a Test LED, LEDs that exhibit certain colors, etc. The user then associates one or more desired LEDs from the list to the newly created event, at step 306.

Further referring to FIG. 3, after associating the LED(s) to the event, the user is then prompted to associate specific LED behavior to the event that will be communicated by the associated LED(s), at step 308. This involves accessing a stored list 310 of available behaviors and selecting one or more options from among the list. The available behaviors may include, for example, the state of the LED (on/off) as the event is detected, blinking, a rate of blinking, etc.

With further reference to FIG. 3, a further aspect in configuring the LED behavior to the newly created event involves associating the behavior duration to the event, at step 312. The duration is selected from a stored list 314 of options, including for example a specified number of seconds, unlimited duration, a duration that terminates upon a reset signal, and the like.

Once the specified LED(s), the behavior, and the behavior duration are configured for a given event, the overall configuration is saved to the configuration database 316, at step 318. The database thus stores the configuration for selection during LED programming, at step 320.

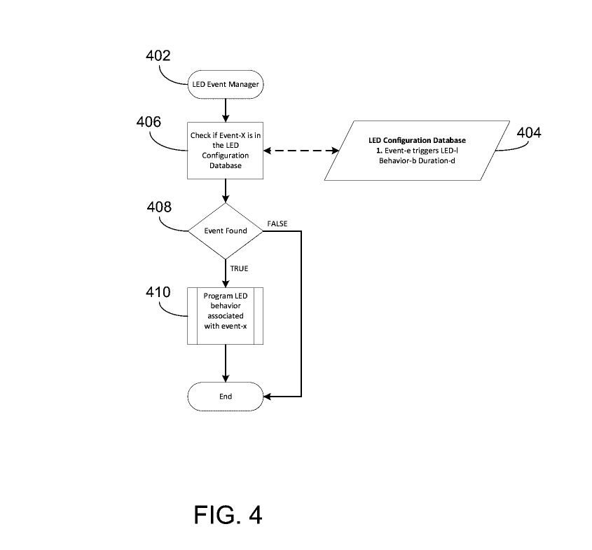

Referring now to FIG. 4, once the custom event has been created (FIG. 2) and configured (FIG. 3), it is placed under the control and monitoring of an LED event manager, at step 402. Generally, when a given event is selected by a user, the event is checked to see whether or not it has been defined and placed into the LED configuration database 404, at step 406. If the event is not found, at step 408, the LED manager carries out no further activity, and the user is prompted to create a new event as explained previously. However, if the event is found, then the user is prompted to program the LED behavior and duration associated with the newly created event, at 410.

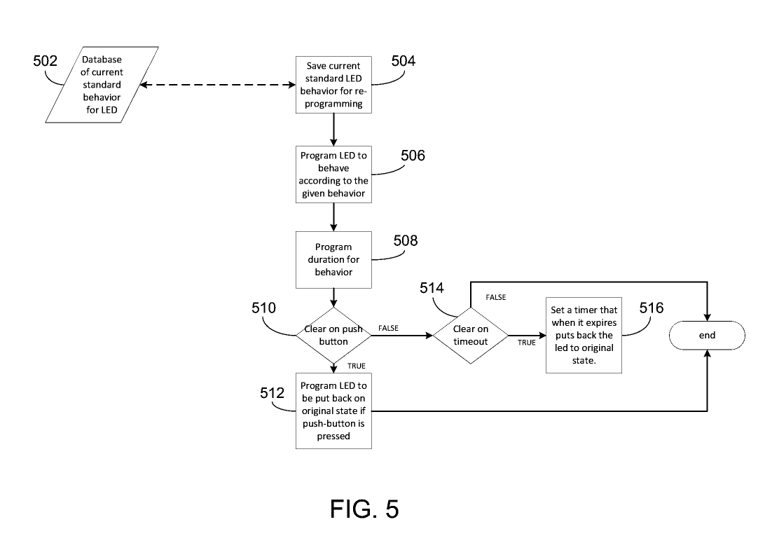

One example of a method of programming the LED(s) is set out in steps illustrated by the flowchart of FIG. 5. With the LED and event configuration complete, and the LED manager able to control the event behavior, controlling or programming of the LED begins by accessing the current standard behavior for the given LED(s) selected for the new event from the configuration database 502, and saving the current behavior for re-programming, at step 504. The LED(s) is then programmed, at step 506, to behave according to the given behavior defined earlier with respect to the LED behavior configuration steps set forth in FIG. 3. Next, the duration for the behavior is programmed, at step 508.

Further referring to FIG. 5, if the duration is tied to a manual push-button reset on the network device housing, determined at step 510, then the LED is programmed to return to the original state if the push-button is pressed, at step 512. Otherwise, if a manual reset function is not set, then a determination is made as to whether the LED behavior duration corresponds to a time-out condition, at step 514. If not, then no further activity occurs, and the duration is assumed to last a pre-set period of time, or for an indefinite time. If a time-out condition is in effect, then a timer is set corresponding to the user-defined time, and upon expiration, the LED is returned to its original state, at step 516.

With the LED(s) programmed as explained above, specific events corresponding to internal activity within a network device may be communicated through activity initiated by a remote administrator to local users in an efficient manner utilizing an existing LED interface often provided with default behaviors. For network troubleshooting applications, this saves money by minimizing network downtime and efficiently communicating status without an abundance of custom hardware or complicated software.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method of operating a network device, the network device including an LED interface that exhibits event behaviors corresponding to detected events, the method comprising:
(a) programmatically accessing the network device;
(b) in a first mode, selecting at least one from a set of predefined event behaviors for the illumination interface, the event behaviors responsive to pre-set criteria; and
(c) in a second mode, programming another event behavior for the illumination interface in response to criteria not included in the pre-set criteria.

2. The method of claim 1, wherein (a) includes remotely logging into the network device.

3. The method of claim 1, wherein (a) includes locally logging into the network device.

4. The method of claim 1, wherein (c)_{—} includes include instructions for:
defining an event;
associating an illumination behavior with occurrence of the defined event, the illumination behavior comprising one from the group including on/off state, blink rate, blink pattern, color, and duration.

5. The method of claim 1, further comprising:
in the second mode, after programming the new event behavior for the illumination interface, adding the new event behavior into the set of predefined event behaviors.

6. The method of claim 1, further comprising:
in the second mode, after programming the new event behavior for the illumination interface, restoring the illumination interface to a default behavior.

7. The method of claim 6, wherein restoring the illumination interface to a default behavior comprises manually resetting the illumination interface to the default behavior.

8. The method of claim 6, wherein restoring the illumination interface to a default behavior comprises resetting the illumination interface to the default behavior in response to a pre-set time limit.

9. A network device comprising:
logic to carry out data networking operations in response to software instructions;
an access interface for coupling to the logic;
at least one LED having a predefined behavior responsive to a pre-set event; and
a programmable interface coupled to the access interface and the LED to configure the at least one LED to exhibit additional behaviors responsive to additional events.

10. The network device of claim 9 embodied as an Ethernet switch.

11. The network device of claim 9, wherein the at least one LED predefined behavior includes one from the following including on/off state, blink rate, blink pattern, color, and duration.

12. The network device of claim 9, and further comprising:
memory to store a configuration database of behaviors; and
wherein additional behaviors configured via the programmable interface are stored in the configuration database.

13. The network device of claim 9, and further comprising:
a reset circuit to restore the LED interface to a default behavior upon programming a new behavior.

14. The network device of claim 9, wherein the reset circuit comprises a manually depressible button.

15. A method for operating a network device, the method being implemented by one or more processors and comprising:
signaling an illumination interface to select, in a first mode, at least one from a set of predefined event behaviors for the illumination interface, the behaviors responsive to pre-set criteria; and
signaling the illumination interface, in a second mode, to exhibit another event behavior for the LED interface in response to criteria not included in the pre-set criteria.
